(19) United States
(12) Patent Application Publication
(10) Pub. No.: US 2022/0377403 A1
(43) Pub. Date: Nov. 24, 2022

(54) DYNAMICALLY ENHANCING A VIDEO BY AUTOMATICALLY GENERATING AND ADDING AN OVERLAY WINDOW

(71) Applicant: INTERNATIONAL BUSINESS MACHINES CORPORATION, ARMONK, NY (US)

(72) Inventors: Cindy Han Lu, San Jose, CA (US); Megan Kostick, Edmonds, WA (US); Michael Brewer, Austin, TX (US); Thai Quoc Tran, San Jose, CA (US)

(21) Appl. No.: 17/303,118

(22) Filed: May 20, 2021

(51) Int. Cl. H04N 21/431; H04N 21/45; H04N 21/466

(52) U.S. Cl. CPC H04N 21/431; H04N 21/4532; H04N 21/466

(57) ABSTRACT

A computer-implemented method for enhancing a video is provided. The method may include generating an annotation matrix comprising extracted video content associated with a video. The method may further include generating a viewer feedback matrix comprising extracted and aggregated viewer feedback, wherein the aggregated viewer feedback comprises a plurality of comments and viewer actions associated with the video, and wherein the plurality of comments appears as text that is located separate from a main window for playing the video. The method may further include generating an overlay matrix by merging the viewer feedback matrix and the annotation matrix. The method may further include generating at least one overlay window for overlaying in the main window of the video at the particular point in time during a playing of the video, wherein the at least one overlay window includes textual information generated from the aggregated viewer feedback.

### BACKGROUND

The present invention relates generally to the field of computing, and more specifically, to enhancing multimedia content.

Generally, a comments section is a feature of online websites, apps, and blogs in which publishers invite an audience to comment on published multimedia content. For websites, such as those that include video content, users may typically make comments in reference to specific content in the video. The comments section may generally be located in a window that is separate from a main window where the video is played and may enable viewers of the video content to post comments in reference to the video. For example, the video may be an instructional cooking video that may include steps for making a certain recipe. Viewers who may view the instructional cooking video may post comments on the video in the comments section, whereby the comments may include suggestions for alternative ingredients, additional steps, parts of the video to skip, warnings, difficult steps in the video so that a viewer may slow down the video, how successful or good was the recipe, etc.

### SUMMARY

A method for enhancing a video is provided. The method may include generating an annotation matrix comprising extracted video content associated with a video. The method may further include generating a viewer feedback matrix comprising extracted and aggregated viewer feedback from a plurality of viewers of the video, wherein the aggregated viewer feedback comprises a plurality of comments and viewer actions associated with the video, and wherein the aggregated viewer feedback comprising the plurality of comments appears as text that is located separate from a main window for playing the video. The method may further include generating an overlay matrix by merging the viewer feedback matrix and the annotation matrix, wherein the overlay matrix correlates the aggregated viewer feedback that is pertinent to a particular point in time in the video with corresponding time points of the extracted video content. The method may further include generating at least one overlay window for overlaying in the main window of the video at the particular point in time during a playing of the video, wherein the at least one overlay window includes textual information generated from the aggregated viewer feedback.

A computer system for enhancing a video is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include generating an annotation matrix comprising extracted video content associated with a video. The method may further include generating a viewer feedback matrix comprising extracted and aggregated viewer feedback from a plurality of viewers of the video, wherein the aggregated viewer feedback comprises a plurality of comments and viewer actions associated with the video, and wherein the aggregated viewer feedback comprising the plurality of comments appears as text that is located separate from a main window for playing the video. The method may further include generating an overlay matrix by merging the viewer feedback matrix and the annotation matrix, wherein the overlay matrix correlates the aggregated viewer feedback that is pertinent to a particular point in time in the video with corresponding time points of the extracted video content. The method may further include generating at least one overlay window for overlaying in the main window of the video at the particular point in time during a playing of the video, wherein the at least one overlay window includes textual information generated from the aggregated viewer feedback.

A computer program product for enhancing a video is provided. The computer program product may include one or more computer-readable storage devices and program instructions stored on at least one of the one or more tangible storage devices, the program instructions executable by a processor. The computer program product may include program instructions to generate an annotation matrix comprising extracted video content associated with a video. The computer program product may further include program instructions to generate a viewer feedback matrix comprising extracted and aggregated viewer feedback from a plurality of viewers of the video, wherein the aggregated viewer feedback comprises a plurality of comments and viewer actions associated with the video, and wherein the aggregated viewer feedback comprising the plurality of comments appears as text that is located separate from a main window for playing the video. The computer program product may also include program instructions to generate an overlay matrix by merging the viewer feedback matrix and the annotation matrix, wherein the overlay matrix correlates the aggregated viewer feedback that is pertinent to a particular point in time in the video with corresponding time points of the extracted video content. The computer program product may further include program instructions to generate at least one overlay window for overlaying in the main window of the video at the particular point in time during a playing of the video, wherein the at least one overlay window includes textual information generated from the aggregated viewer feedback.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an example diagram illustrating a comment overlay window that is overlayed and displayed in a main window of a video and that includes text/keywords from user comments according to one embodiment;

FIG. 3 is an operational flowchart illustrating the steps carried out by a program for generating the comment overlay window according to one embodiment;

FIG. 4 is an example of an annotation matrix according to one embodiment;

FIG. 5 is an exemplary data table illustrating data that may be included in the overlay matrix according to one embodiment;

FIG. 6 is a block diagram of the system architecture of the program for automatically and cognitively generating a comment overlay window that is overlayed and displayed in a main window of a video and that includes text/keywords from user comments according to one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to enhancing multimedia content. The following described exemplary embodiments provide a system, method and program product for automatically and cognitively generating and adding a comment overlay window to a video. Specifically, the present embodiment has the capacity to improve the technical field associated with video streaming on a computing device, by automatically and cognitively overlaying, adding, and displaying in a main window of a video, and at particular points in time during a playing of the video, a comment overlay window that includes keywords from one or more comments derived from a comments section. More specifically, the system, method and program product may parse and detect video content associated with a video, aggregate feedback from a comments section that is associated with the video, and correlate the aggregated feedback from the comments section with the parsed content from the video to generate and display one or more overlay windows that include keywords from the comments section.

As previously described with respect to a comments section associated with multimedia content, the comments section may generally be located below the multimedia content on a webpage and/or web application. For example, the multimedia content may include instructional videos, such as do-it-yourself (DIY) videos, cooking videos, and software-related videos, and user comments may be listed under the instructional video in a comments section. More specifically, for example, and in reference to the mentioned instructional videos, the comments sections may include comments such as alternative ingredients, additional steps, updates to versions of software, which versions of software may not be compatible, parts of the video to skip, warnings, difficult steps in the video to let a user know to slow down the video, how successful was the instructional video, etc. Furthermore, users may use the comments section to fact check information presented in a video. However, due to the volume of comments that may be presented in the comments section, many of these useful comments may not be viewed or may get lost in the mix of comments that are presented.

As such, it may be advantageous, among other things, to provide a method, computer system, and computer program product for enhancing video content by automatically and cognitively generating a comment overlay window. Specifically, the method, computer system, and computer program product may overlay, add, and display in a main window of a video, and at particular points in time during a playing of the video, a comment overlay window that includes text/keywords from one or more comments derived from a comments section. Specifically, the method, computer system, and computer program product may parse and detect video content associated with a video, aggregate feedback from a comments section that is associated with the video, and correlate the aggregated feedback from the comments section with the parsed content from the video to generate and display one or more overlay windows that include text/keywords from the comments section that corresponds to a portion of the video content.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

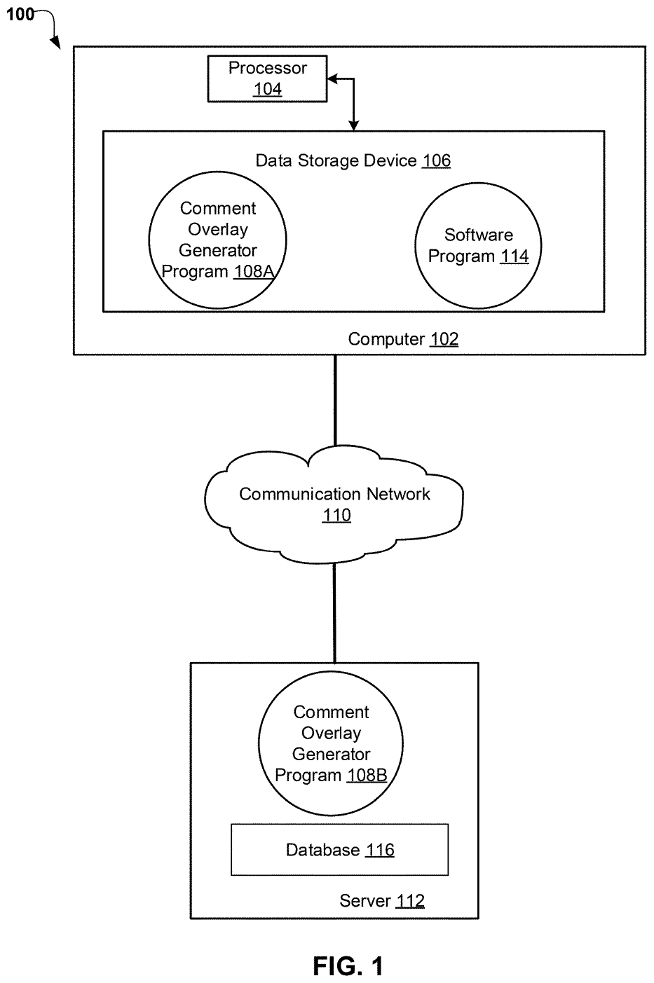

Referring now to FIG. 1, an exemplary networked computer environment 100 in accordance with one embodiment is depicted. The networked computer environment 100 may include a computer 102 with a processor 104 and a data storage device 106 that is enabled to run a comment overlay generator program 108A and a software program 114, and may also include a microphone (not shown). The software program 114 may be an application program such as an internet browser and/or one or more mobile apps running on a client computer 102, such as a mobile phone device. The comment overlay generator program 108A may communicate with the software program 114. The networked computer environment 100 may also include a server 112 that is enabled to run a comment overlay generator program 108B and the communication network 110. The networked computer environment 100 may include a plurality of computers 102 and servers 112, only one of which is shown for illustrative brevity. For example, the plurality of computers 102 may include a plurality of interconnected devices, such as a mobile phone, tablet, and laptop, associated with one or more users.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

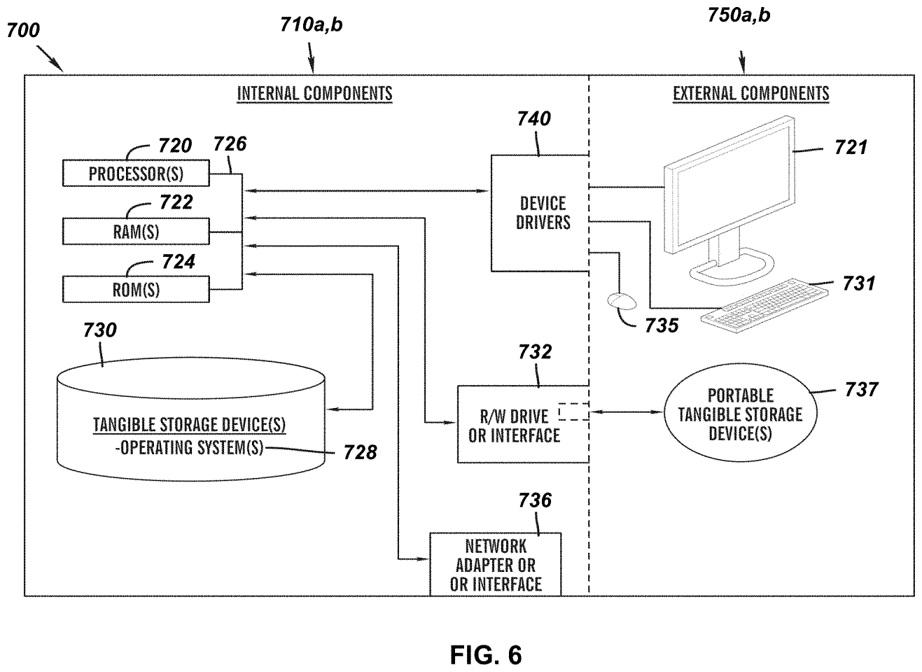

The client computer 102 may communicate with server computer 112 via the communications network 110. The communications network 110 may include connections, such as wire, wireless communication links, or fiber optic cables. As will be discussed with reference to FIG. 6, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the comment overlay generator program 108A, 108B may interact with a database 116 that may be embedded in various storage devices, such as, but not limited to, a mobile device 102, a networked server 112, or a cloud storage service.

According to the present embodiment, a program, such as a comment overlay generator program 108A and 108B may run on the client computer 102 and/or on the server computer 112 via a communications network 110. The comment overlay generator program 108A, 108B may provide a comment overlay window, for overlaying in a main window of video content, user comments that correspond to particular points in time and context of the video content. Specifically, a client computer 102, such as a desktop computer, laptop computer, tablet, and/or mobile device, may run a comment overlay generator program 108A, 108B, that may interact with a database 116 and a software program 114, to automatically and cognitively generate a comment overlay window on the video and display, at particular points in time during a playing of the video, keywords from comments derived from a comments section associated with the video. More specifically, the comment overlay generator program 108A, 108B may parse and detect video content associated with a video, aggregate feedback from a comments section that is associated with the video, and correlate the aggregated feedback from the comments section with the parsed content from the video. In turn, the comment overlay generator program 108A, 108B may generate and display one or more overlay windows that include text/keywords from a comment corresponding to a portion of the video content.

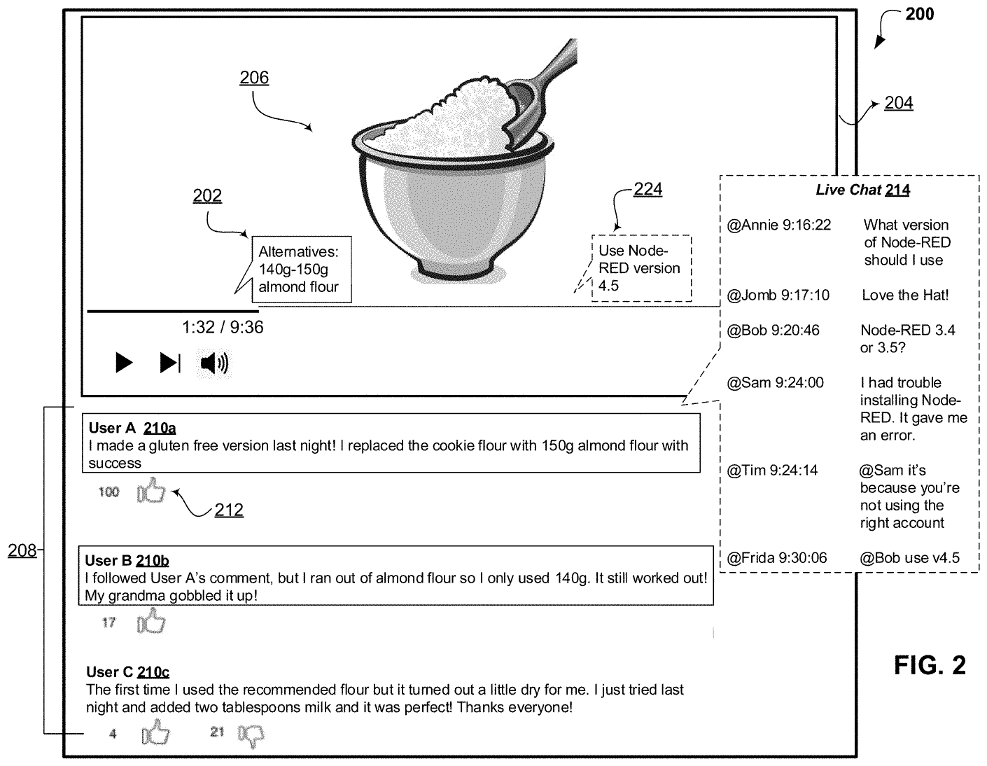

Referring now to FIG. 2, an example diagram 200 illustrating a comment overlay window 202 that is overlayed and displayed in a main window of a video and that includes text/keywords from user comments according to one embodiment is depicted. Specifically, example diagram 200 may be a webpage that includes a video 204 with video content 206. The webpage may also include a comments section 208 that is associated with the video 204 where users may post comments 210a, 210b, 210c that may reference the video content 206 within the video 204. For example, the video 204 may be an instructional cooking video that includes video content 206 for making cookies and a cake. Specifically, the video content 206 may, for example, include details about the ingredients for a recipe for making cookies and cake.

However, and as indicated by the comments 210a, 210b, 210c in the comments section 208, users may suggest alternative ingredients for making cookies. Specifically, the comment overlay generator program 108A, 108B may aggregate feedback from viewers of the video, wherein the feedback includes user comments, frequency of the keywords used in the comments, and other user actions including upvotes/downvotes, traffic, referrers, and clicks. According to one embodiment, the feedback in the form of comments may appear as text in a comments section 208 or chat pane (such as live chat 214) that is separate from a window for playing the video. For example, and previously described, users may post comments 210a, 210b, 210c in the comments section 208 that may reference the video content 206 within the video 204. Specifically, as indicated in the posted comment 210a, User A may suggest an alternative gluten free ingredient for making cookies by using “150 g almond flour” as opposed to the “cookie flour” that may have been mentioned in the video 204. Furthermore, as depicted in comment 210b, User B may refer to User A's comment and similarly suggest using almond flour but with 140 g. As indicated by popularity indicator 212, both comments 210a and 210b regarding the almond flour ingredient may be popular among other users who may view the comment section 208 and/or may have tried the recipe with the almond flour. Specifically, the popularity indicator 212 may be based on a thumbs up icon indicating that users like the comment and/or suggestion posted by a user. Opposingly, comment 210c from User C may not be viewed as being popular among users viewing the video 204 based on more users clicking a thumbs down icon indicating a dislike for User C's comment.

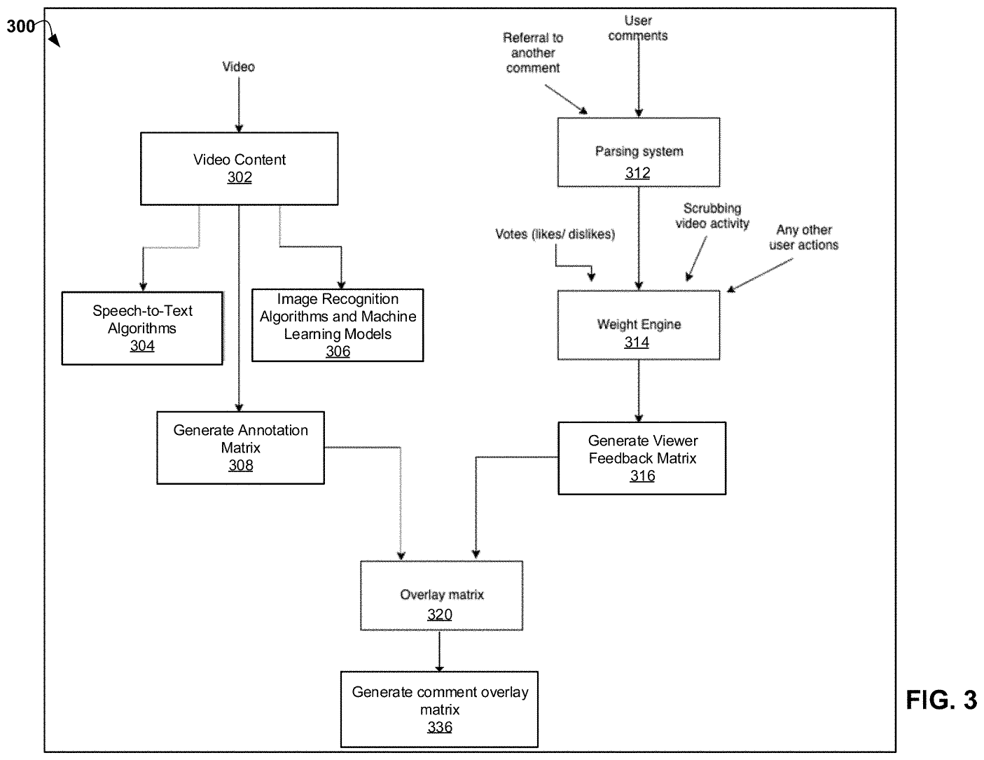

As will be further described in greater detail with reference to FIGS. 3-5, the comment overlay generator program 108A, 108B may automatically and continuously parse the video and/or video stream 204 to determine, for example, a time in the video content 206 that the “flour” ingredient is mentioned, and more specifically, a context in which the flour ingredient is mentioned (i.e. in the context of cookies or cake). Additionally, the comment overlay generator program 108A, 108B may automatically and continuously parse and extract the aggregated feedback from viewers of the video 204, such as by identifying and extracting the keywords, context, time, and popularity of the comments 210a and 210b. In turn, the comment overlay generator program 108A, 108B may determine a relationship between the portion of the video content 206 that mentions cookie flour for cookies and the comments 210a, 210b, 210c that suggest alternative flour ingredients for cookies.

Thus, in response to the posting of comments 210a, 210b, 210c, and based on the extraction and analysis process that will be further described in FIGS. 3-5, the comment overlay generator program 108A, 108B may generate a comment overlay window 202 which may be overlayed and displayed on the video 204 at the particular point in time that the flour ingredient for cake is mentioned in the video 204. For example, at the time the discussion of the flour ingredient for cookies is presented in the video 204 (and based on the relevance and popularity of comments 210a and 210b), the comment overlay generator program 108A, 108B may overlay and display a comment overlay window 202 that includes text stating, “Alternatives: 140 g-150 g almond flour.” Furthermore, according to one embodiment, the comment overlay generator program 108A, 108B may also determine the particular point in time to overlay and display the comment overlay window 202 on the video 204 based a mention of time in the comment itself. For example, the posted comment 210a may instead recite, “@1:32 I made a gluten free version last night! I replaced the cake flour with 150 g almond flour with success.” Thus, accordingly, the comment overlay generator program 108A, 108B may identify, based on the “@1:32” included in comment 210a, that User A is specifically referencing the video content 206 at 1:32. Therefore, the comment overlay generator program 108A, 108B may specifically determine that the particular point in time to overlay and display the comment overlay window 202 on the video 204 should start at 1:32 into the video 204.

According to another embodiment (as indicated by the dotted outlines in FIG. 2), the comments section 208 may be a live chat 214. Specifically, the video 204 may be a live video where the video content 206 includes content that is being displayed in real-time, whereby users are viewing the video 204 live and commenting on the video 204 in real-time as well. For example, the live video 204 may be an instructional video regarding software. As indicated by the comments 220a, 220b, 220c in the live chat 214, a user may suggest a version of software to install. For example, and as indicated in the posted comment 220a, Annie at time 9:16:22 may ask about a certain version of software called Node-RED. Furthermore, as depicted in live chat 214, Bob at 9:20:46 may ask about specific versions of the software Node-RED, i.e. version “3.4 or 4.5.” Frida at 9:30:06 may in response indicate to Bob to “use v4.5.” As previously described, relevance and popularity of a comment may be based on a number of different user actions and factors that include, among others, the contents of the comments in the chat, frequency of keywords, upvotes, traffic, referrers, clicks, a determined sentiment associated with each comment, etc. Thus, following the most previous example, the comment overlay generator program 108A, 108B may detect that the software called “Node-RED” is mentioned frequently in the live chat 214. Furthermore, the comment overlay generator program 108A, 108B may detect (from parsing, extraction, and analysis) a suggested answer to which version of the software to use. Therefore, based on the frequency of the term “Node-RED” and a detection of a specific discussion on the different versions, the comment overlay generator program 108A, 108B may determine a relationship between the comments 220a, 220b, 220c and a suggestion of using version 4.5. Thus, the comment overlay generator program 108A, 108B may generate a comment overlay window 224 which includes text that may state, “Use Node-RED version 4.5,” and may overlay and display the comment overlay window 224 on the video 204 at the particular point in time that the relevant comment is posted (i.e. @9:30:06, based on Frida's comment 220c), and/or on a time thereafter depending on the speed between analyzing the comments and generating the comment overlay window. Therefore, according to one embodiment, the comment overlay generator program 108A, 108B may be applied to a live video 204 and live chat 214.

As described with respect to a live video 204, based on possible delays between the analysis performed by the comment overlay generator program 108A, 108B and the resulting generation of the comment overlay window 224, there may be a time delay before the comment overlay window is displayed on the live video 204 (i.e. after @9:30:06). However, according to one embodiment, in a replay of the live video 204, the comment overlay generator program 108A, 108B may more timely display the comment overlay window 224 on the video 204—for example, when the live video is replayed, the comment overlay generator program 108A, 108B may more accurately display the window 224 @9:30:06 to represent a more accurate depiction of the time that a comment relevant to the content in the video is posted (since the comments already presented due to the replay). Thus, and as will be further described with respect, the comment overlay generator program 108A, 108B may continuously scan, parse, extract, and analyze the comments associated with a video each time a video may be viewed to detect new comments and comment edits as well as to accurately display comment overlay windows on the video.

As previously described, and as will be further described with reference to FIG. 3, a method, computer system, and computer program product for generating a comment overlay window may first begin with parsing, extracting, and transcribing video content associated with a video as well as parsing and extracting aggregated feedback from viewers of the video. To that end, an operational flowchart 300 in FIG. 3 illustrates steps carried out by a program for generating the comment overlay window. Specifically, FIG. 3 illustrates a process for generating an annotation matrix and a viewer feedback matrix, and then merging the annotation matrix with the viewer feedback matrix to generate an overlay matrix that may determine a relationship between the video content and the aggregated feedback. Specifically, and as depicted in FIG. 3 at 302, the comment overlay generator program 108A, 108B may detect identify video content associated with a video. More specifically, for example, the comment overlay generator program 108A, 108B may detect initialization of a video, which may include detecting an upload of a video (i.e. when a video creator uploads a video) and/or detecting that the video is loaded by a website or app in response to an internet request for the video. Then, in response, the comment overlay generator program 108A, 108B may identify the video content associated with the video. Thereafter, and as depicted at 304, the comment overlay generator program 108A, 108B automatically transcribe audio of the video using speech-to-text algorithms and natural language processing which may also be used to specifically identify keywords in the transcribed audio. Simultaneously, and as depicted at 306, the comment overlay generator program 108A, 108B may also automatically recognize objects rendered at various points in time in the video using an image recognition algorithm and a machine learning model. For example, the comment overlay generator program 108A, 108B may use speech-to-text algorithms (also referred to as computer recognition speech algorithms and automatic speech recognition algorithms) such as Hidden Markov model (HMM), Mel frequency cepstral coefficients (MFCC), linear prediction cepstral coefficients (LPCC), vector quantization (VQ), dynamic time warping (DTW), artificial neural networks (ANNs), and deep learning neural networks. Furthermore, the comment overlay generator program 108A, 108B may use image recognition algorithms such as SIFT (Scale-invariant Feature Transform), SURF (Speeded Up Robust Features), PCA (Principal Component Analysis), LDA (Linear Discriminant Analysis), and convolutional neural networks (CNNs).

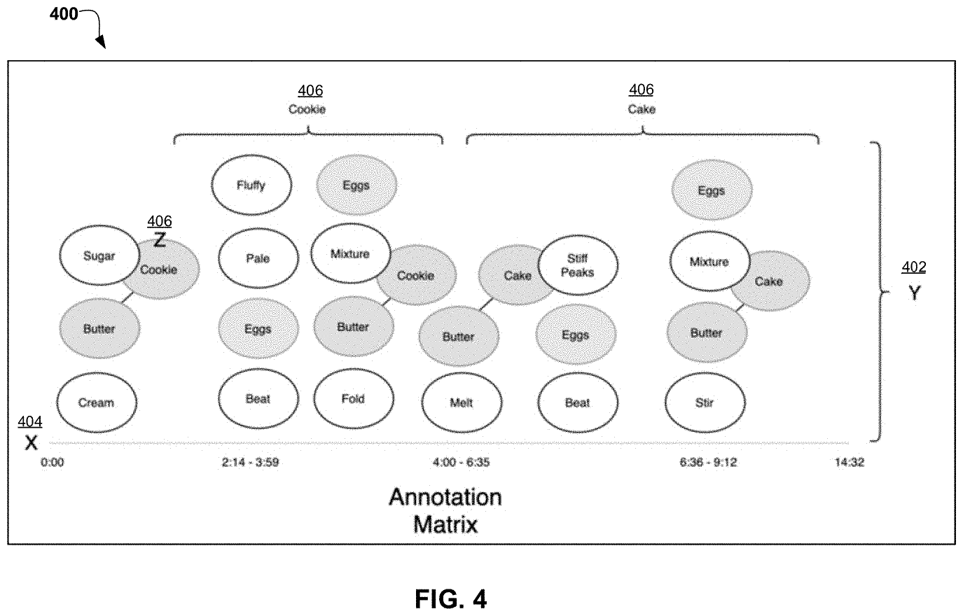

In turn, the comment overlay generator program 108A, 108B may use the information that is extracted from a video via the speech-to-text algorithms and the image recognition algorithms to generate an annotation matrix as depicted at 308 in FIG. 3. A detailed example/description of the generated annotation matrix (and a viewer feedback matrix) is depicted in FIG. 4. Specifically, the annotation matrix may be a data matrix that identifies a relationship between the transcribed and extracted keywords and objects in the video, whereby the annotation matrix maps each keyword and object to a matrix node with timeframe and context information. More specifically, and as depicted in the example annotation matrix 400 in FIG. 4, the comment overlay generator program 108A, 108B may identify and represent the data extracted from the video using a 3-axis framework, whereby a y-axis 404 may include the identified keywords and/or objects in the data, an x-axis 402 may include a timeframe of the keywords and/or objects (i.e. at what time the keywords and objects are mentioned in the video), and a z-axis 406 may include associated nouns, verbs, and objects that are detected for context to the keywords and objects (as an example, for a keyword such as “milk,” image recognition may also detect that low-fat milk is being used in the video to further give context to the keyword “milk”). As specifically depicted in FIG. 4, the comment overlay generator program 108A, 108B may generate an annotation matrix for an instructional cooking video 204 (FIG. 2) from the previously described example in FIG. 2. In doing so, and as depicted in the y-axis 404, the comment overlay generator program 108A, 108B may identify keywords in the video such as sugar, butter, eggs, cream, mixture, melt, etc. Also as depicted in the x-axis 402, the comment overlay generator program 108A, 108B may identify the time where the keywords are mentioned in the instructional cooking video, such as by identifying that the keywords fluffy, pale, eggs, and beat are mentioned in the 2:14-3:59 time range of the video 204 (FIG. 2). However, and as previously described, certain keywords may be mentioned or viewed in different context and/or at different times of a video. For example, the keyword “butter” is mentioned throughout the instructional cooking video, however, in different context—i.e. a) with respect to making cookies and b) with respect to making a cake. As such, the comment overlay generator program 108A, 108B may use the z-axis 406 to identify associative nouns, verbs, and objects that may determine a context for a given keyword. In turn, the comment overlay generator program 108A, 108B may narrow down a meaning and context associated with the keywords and objects. For example, and as depicted in FIG. 4, the comment overlay generator program 108A, 108B may use the speech-to-text algorithms and the image recognition algorithms to differentiate the context of butter by determining that the first two instances 414 of the keyword “butter” is in reference to cookies, while the other two instances 416 of the keyword “butter” is in reference to cake.

As previously described, the method, computer system, and computer program product for generating a comment overlay window may first begin with parsing and transcribing a video as well as the comments associated with the video. Specifically, parsing, transcribing, and extracting video content from a video to generate an annotation matrix has been discussed. Similarly, and referring back to FIG. 3, the comment overlay generator program 108A, 108B may also parse and extract the aggregated feedback from viewers of the video to generate a viewer feedback matrix. More specifically, the viewer feedback matrix may include a keyword map that maps text/keywords from each viewer comment to a matrix node with timeframe and context information. As depicted at 312 in FIG. 3, the comment overlay generator program 108A, 108B may automatically parse and extract user comments from a comments section 208 of a video in response to users posting a comment. According to one embodiment, the comment overlay generator program 108A, 108B may use a combination of natural language processing algorithms, image recognition algorithms, as well as machine learning and deep learning models (such as CNNs), to parse and identify the keywords, time, and context in a user comment.

Thus, the comment overlay generator program 108A, 108B may identify keywords in a comment, the frequency of keywords in user comments, a context associated with a user comment, a time associated with a comment (i.e. the time a comment is posted) as well as a time that references a point/part in a video (i.e. a user comment that references a specific time in the video), and relationships/referrals between comments. For example, and referring back to FIG. 2, the comment overlay generator program 108A, 108B may identify a keyword such as “flour” in the comments 210a, 210b, 210c. Based on the natural language processing algorithms and deep learning models, the comment overlay generator program 108A, 108B may identify a context associated with the comments and a relationship between the comments. For example, the comment overlay generator program 108A, 108B may identify that the “flour” mentioned in the comment from User A 210a references the portion of the video that discusses the cookie recipe as opposed to the cake recipe based on the contextual word “cookie” in the comment 210a. The comment overlay generator program 108A, 108B may also identify that the “flour” specifically refers to “almond flour” as an alternative to cookie flour. The comment overlay generator program 108A, 108B may also identify “150 g” as a measurement for the “almond flour.” The comment overlay generator program 108A, 108B may also establish a relationship between comments 210a and 210b by identifying that comment 210b from User B is referring to comment 210a from User A based on a mentioning of User A in comment 210b. The comment overlay generator program 108A, 108B may also identify that the “flour” in comment 210b also specifically refers to “almond flour” and may identify “140 g” is a suggested measurement.

Furthermore, and as depicted at weight engine 314, in addition to parsing text in user comments to establish a context/relationship associated with the user comments, the comment overlay generator program 108A, 108B may also use machine learning and deep learning models to aggregate and correlate other viewer feedback that include viewer actions such as upvotes/downvotes on a user comment (for example, identifying a number likes and dislikes of a comment based on a popularity icon 212), video scrubbing activity (such as determining when users are viewing and/or skipping to certain parts of a video) and metadata such as reply comments and other surrounding text associated with a user comment. As previously described, the viewer feedback matrix may be a keyword map that maps text/keywords from each viewer comment to a matrix node with timeframe and context information. In addition, the keyword map may parse viewer actions and map the viewer actions to keywords as well. In turn, based on such information, the comment overlay generator program 108A, 108B may weigh the aggregated feedback. More specifically, the comment overlay generator program 108A, 108B may weigh certain comments over other comments in the comments section based on the weighed aggregated feedback.

For example, and as previously described with respect to FIG. 2, a popularity indicator 212 may be used to identify that both comments 210a and 210b regarding the almond flour ingredient may be popular among users viewing the comment section 208. In the example, the popularity indicator 212 may be based on a thumbs up icon indicating that users like the comment or suggestion posted by the user. Opposingly, comment 210c from User C may not be viewed as being popular among users viewing the video 204 and/or the comments section 208 based on more users clicking a thumbs down icon indicating a dislike for User C's comment. In turn, the viewer feedback matrix may be used to map the viewer actions that are performed on the popularity indicator 212 to the text and keywords included in the comments. For example, the viewer feedback matrix may map the viewers' upvotes (i.e. “likes” using the popularity indicator 212) on the user comments 210a and 210b to the text and keywords included in the comments. Thereafter, based on the mapped viewer actions including the upvotes and any other reactions to the comment (such as downvotes on the user comment, video scrubbing activity, and other user actions), the comment overlay generator program 108A, 108B may assign a weight to the comments and the text/keywords from the comments using the viewer feedback matrix at 316. For example, the weighted score may be based on a weighting scale, such as 0-100, whereby 0 represents a comment/keyword that is given the lowest weight and 100 represents a comment/keyword that is given the highest weight. As such, following the previous example, because popularity indicator 212 indicates that both comments 210a and 210b regarding the almond flour ingredient may be popular among users, the comment overlay generator program 108A, 108B (using machine learning and deep learning models) may determine to assign a higher weighted score, such as 90, to the comment and keyword terms—“almond flour,” “150 g,” and “140”—that are in comments 210a and 210b over comment and keywords terms of the comment 210c when determining to generate an overlay window 202, 224. Also, for example, and based on video scrubbing activity, in response to determining that most users are specifically viewing the cookie recipe located in the first half of the video but not viewing the cake recipe located in the second half of the video, the comment overlay generator program 108A, 108B may determine to weigh comments and keywords discussing the cookie recipe more heavily than comments and keywords discussing the cake recipe.

In turn, and as depicted in FIG. 3, the comment overlay generator program 108A, 108B may use the extracted data to generate a viewer feedback matrix at 316, which may be similar to the annotation matrix (in that, the viewer feedback matrix also includes the 3-axis framework). However, the generated viewer feedback matrix 316 will include the keywords and keyword terms from user comments in a comments section 208 of the video as well as may include assigned weighted scores for the keywords (for illustrative brevity, only the annotation matrix is shown in FIG. 4 but the viewer feedback matrix will similarly include the 3-axis framework that would instead be based on the user comments).

Thereafter, and as depicted at 320 in FIG. 3, the comment overlay generator program 108A, 108B may overlay or merge the generated viewer feedback matrix that is based on the aggregated viewer feedback with the generated annotation matrix that is associated with the video to generate an overlay matrix, whereby the overlay matrix may determine a correlation between the comments in the comments section and the video content in the video. Specifically, for the overlay matrix, the comment overlay generator program 108A, 108B may feed the annotation matrix and the viewer feedback matrix into a machine learning engine to correlate the 3-axis framework associated with the viewer feedback matrix and the 3-axis framework associated with the annotation matrix. More specifically, the comment overlay generator program 108A, 108B may correlate and determine top keywords between the viewer feedback matrix and the annotation matrix (top keywords may include most frequently mentioned and/or commonly shared keywords, which may also be based on a configurable threshold value—such as keywords used an X amount of time or shared an X amount of time may be considered top keywords). Furthermore, the comment overlay generator program 108A, 108B may determine relationships between the keywords and context associated with the viewer feedback matrix and the keywords and context associated with the annotation matrix such as by determining a semantic relationship between the keywords and context, determining similar nouns and verbs surrounding the keywords for further context, determining a timing relationship between the keywords from the viewer feedback matrix and the annotation matrix, and determining possible related metadata. Therefore, the generated overlay matrix may similarly include a 3-axis framework (keyword, time, and context—as well as include the weighted scores) that correlates the data associated with the annotation matrix with the data associated with the viewer feedback matrix.

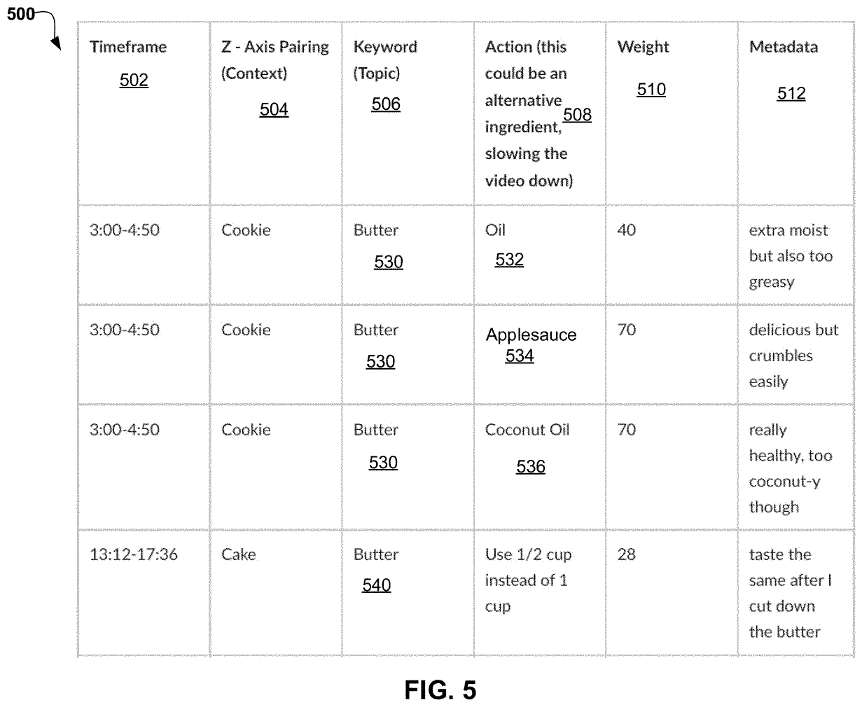

FIG. 5 is an exemplary data table 500 illustrating data that may be included in the overlay matrix. Specifically, and as depicted in FIG. 5, the generated overlay matrix that is based on the combined and correlated data from the annotation matrix and the viewer feedback matrix, may include: a keyword 506 from a video (which may be derived from the annotation matrix); a timeframe 502 associated with the keyword in the video; a context 504 associated with the keyword from the video (which may be based on a z-axis pairing between the annotation matrix and the viewer feedback matrix); alternative actions, keywords, and keyword terms 508 based on user comments (which may be derived from the viewer feedback matrix); an assigned weight 510 to the keyword and keyword terms based on other user actions; and associative text/metadata 512 that gives further context to the keyword and keyword terms based on the user comments.

For example, taking an instructional cooking video, the data from the generated overlay matrix may include a timeframe of when the keyword “butter” 506 is mentioned in the video. The data from the generated overlay matrix may also include the context 504 in which the keyword “butter” is mentioned. According to one embodiment, the context may be based on a pairing between the z-axis from both the annotation matrix and the viewer feedback matrix. As previously described with respect to FIG. 4, the z-axis in both the annotation matrix and the viewer feedback matrix may represent the context in which a keyword is mentioned, respectively. Furthermore, and as previously described in FIG. 3, the comment overlay generator program 108A, 108B may combine the annotation matrix with the viewer feedback matrix to generate an overlay matrix that may establish a relationship between keyword context from a video and keyword context from comments in a comment section that is associated with the video. Thus, for example, and as depicted in the first three entries of FIG. 5, the comment overlay generator program 108A, 108B may detect from the overlay matrix that the first three entries of the keyword “butter” 530 is mentioned in the context 504 of the cookie recipe. The comment overlay generator program 108A, 108B may also detect from the overlay matrix that: 1) in a first entry 532, a first comment includes an alternative action or keyword term, “oil,” and also references the keyword “butter” in the context of a cookie between 3:00 and 4:50; 2) in a second entry 534, a second comment includes an alternative action or keyword term, “applesauce,” and also references “butter” in the context of a cookie between 3:00 and 4:50; and 3) in a third entry 536, a third comment includes an alternative action or keyword term, “coconut oil,” and also references “butter” in the context of a cookie between 3:00 and 4:50. Furthermore, the comment overlay generator program 108A, 108B may detect in a fourth entry that the keyword “butter” 540 is mentioned in the context 504 of the cake recipe and that a fourth comment includes an alternative action or keyword term/phrase, “use ½ cup instead of 1 cup,” in reference to “butter” in the context of a cake between 9:12 and 9:36.

Additionally, and as previously described, weighted scores 510 may be assigned to each of the alternative actions, keywords, and keyword terms 508, based on user actions. For example, and as previously described with respect to the weight engine 314 in FIG. 3, the comment overlay generator program 108A, 108B may use machine learning and deep learning models to detect user actions such as upvotes/downvotes on a user comment (for example, identifying a number likes and dislikes of a comment based on a popularity icon 212), video scrubbing activity (such as determining when users are viewing and/or skipping to certain parts of a video) and metadata that may include other surrounding text and reply comments associated with a user comment. Thereafter, based on such information, the comment overlay generator program 108A, 108B may weigh keywords and/or keyword terms in certain comments, which may include alternative actions, over other keywords in other comments in the comments section. The weighted scores may also be merged into the overlay matrix as previously described in FIG. 3. Thus, referring to FIG. 5 and as depicted at 512, the overlay matrix may include weighted scores for the alternative actions at 510.

For example, based on analysis of user actions associated with the user comment that includes “coconut oil” for the cookie recipe—for instance, identifying reactions to the user comment, including a detection of positive reply comments and upvotes for the user comment (i.e. a threshold number of upvotes)—the alternative action of “coconut oil” for the cookie recipe may be considered a highly popular alternative to butter and based on an assigned weighted score of 90. Opposingly, based on analysis of user actions associated with the user comment that includes “use ½ cup instead of 1 cup” for the cake recipe—for instance, identifying reactions to the user comment, including a detection of negative reply comments and downvotes votes, and a detection that a majority of users do not view the cake recipe—the alternative action of “use ½ cup instead of 1 cup” for the cake recipe may be considered a low alternative to butter based on an assigned weighted score of 28.

Then, as depicted at 336 in FIG. 3, the comment overlay generator program 108A, 108B may use the overlay matrix to automatically and cognitively generate at least one comment overlay window. Specifically, the comment overlay generator program 108A, 108B may overlay and render in a main window of a video, and at a particular point in time during a playing of the video, a comment overlay window that may include text/keywords based on the aggregated viewer feedback. According to one embodiment, and as depicted in FIG. 2 at 202 and 224, the at least one comment overlay window may be smaller than the main window and may include textual information generated from the viewer feedback for rendering at particular points in time in the video at which the viewer feedback is relevant to the recognized objects and audio of the video. More specifically, using machine learning and deep learning algorithms, the comment overlay generator program 108A, 108B may use the correlated data between the user comments and the video content (based on the overlay matrix), as well as use the weighted scores, to cognitively generate natural language text based on keywords from user comments to include in a comment overlay window. For example, and referring back to FIG. 2, in the posted comment 210a, User A may suggest an alternative gluten free ingredient for making cookies by using “150 g almond flour” as opposed to the “cookie flour” that may have been mentioned in the video 204. Furthermore, as depicted in FIG. 2, User B may similarly suggest using almond flour in comment 210b but with 140 g. Furthermore, as indicated by popularity indicator 212, both comments 210a and 210b regarding the “almond flour” ingredient may be popular among other users who may view the comment section 208 and/or may have tried the recipe with the almond flour. Specifically, the popularity indicator 212 may be based on a thumbs up icon indicating that users like the comment and/or suggestion posted by a user.

Accordingly, based on the overlay matrix, the comment overlay generator program 108A, 108B may determine a time in the video content 206 that the “flour” ingredient is mentioned specifically with reference to cookies (as opposed to cake). Additionally, the comment overlay generator program 108A, 108B may identify the context and popularity of the comments 210a and 210b with respect to the flour ingredient for cookies. Therefore, the comment overlay generator program 108A, 108B may determine a relationship between the portion of the video content 206 that mentions the flour ingredient for cookies and the comments 210a, 210b, 210c that suggest alternative flour ingredients for cookies. Thus, the comment overlay generator program 108A, 108B may generate a comment overlay window 202 and may overlay and display the comment overlay window 202 on the video 204 at the particular point in time that the flour ingredient for cookies is mentioned in the video 204. For example, at the time the discussion of the flour ingredient is presented in the video 204, the comment overlay generator program 108A, 108B may overlay and display a comment overlay window 202 that combines keywords from comments 210a and 210b and includes text stating, “Alternatives: 140 g-150 g almond flour.” According to one embodiment, the comment overlay generator program 108A, 108B may also determine the particular point in time to overlay and display the comment overlay window 202 on the video 204 based a mention of time in the comment itself. For example, the posted comment 210a may instead recite, “@1:32 I made a gluten free version last night! I replaced the cookie flour with 150 g almond flour with success.” Thus, accordingly, the comment overlay generator program 108A, 108B may identify, based on the “@1:32” included in comment 210a, that User A is specifically referencing the video content 206 at 1:32. Therefore, the comment overlay generator program 108A, 108B may specifically determine that the particular point in time to overlay and display the comment overlay window 202 on the video 204 should start at 1:32 into the video 204.

It may be appreciated that FIGS. 1-5 provide only illustrations of one implementation and does not imply any limitations with regard to how different embodiments may be implemented. Many modifications to the depicted environments may be made based on design and implementation requirements. For example, according to one embodiment, the comment overlay generator program 108A, 108B may detect whether a user comment does not provide enough information to fill one or more of the axes in the 3-axis framework associated with the viewer feedback matrix (i.e. the x-axis, y-axis, and z-axis), such as missing timeframe information and/or context information. As such, in response to a user posting a comment, the comment overlay generator program 108A, 108B may present a chatbot to follow up with a question to the user posting the comment to ask the user to provide such information. For example, in response to a user posting a comment simply stating, “coconut oil instead of butter”, the comment overlay generator program 108A, 108B may present a chatbot to ask the user, “Which part of the recipe are you referring to replace the butter?”

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

FIG. 6 is a block diagram 700 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 710, 750 is representative of any electronic device capable of executing machine-readable program instructions. Data processing system 710, 750 may be representative of a smart phone, a computer system, PDA, or other electronic devices. Examples of computing systems, environments, and/or configurations that may represented by data processing system 710, 750 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 710 a, b and external components 750 a, b illustrated in FIG. 6. Each of the sets of internal components 710 a, b includes one or more processors 720, one or more computer-readable RAMs 722, and one or more computer-readable ROMs 724 on one or more buses 726, and one or more operating systems 728 and one or more computer-readable tangible storage devices 730. The one or more operating systems 728, the software program 114 (FIG. 1) and the comment overlay generator program 108A (FIG. 1) in client computer 102 (FIG. 1), and the comment overlay generator program 108B (FIG. 1) in network server computer 112 (FIG. 1) are stored on one or more of the respective computer-readable tangible storage devices 730 for execution by one or more of the respective processors 720 via one or more of the respective RAMs 722 (which typically include cache memory). In the embodiment illustrated in FIG. 6, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 710 a, b, also includes a R/W drive or interface 732 to read from and write to one or more portable computer-readable tangible storage devices 737 such as a CD-ROM, DVD, memory stick, magnetic tape, magnetic disk, optical disk or semiconductor storage device. A software program, such as an comment overlay generator program 108A and 108B (FIG. 1), can be stored on one or more of the respective portable computer-readable tangible storage devices 737, read via the respective R/W drive or interface 732, and loaded into the respective hard drive 730.

Each set of internal components 710 a, b also includes network adapters or interfaces 736 such as a TCP/IP adapter cards, wireless Wi-Fi interface cards, or 3G or 4G wireless interface cards or other wired or wireless communication links. The comment overlay generator program 108A (FIG. 1) and software program 114 (FIG. 1) in client computer 102 (FIG. 1), and the comment overlay generator program 108B (FIG. 1) in network server 112 (FIG. 1) can be downloaded to client computer 102 (FIG. 1) from an external computer via a network (for example, the Internet, a local area network or other, wide area network) and respective network adapters or interfaces 736. From the network adapters or interfaces 736, the comment overlay generator program 108A (FIG. 1) and software program 114 (FIG. 1) in client computer 102 (FIG. 1) and the comment overlay generator program 108B (FIG. 1) in network server computer 112 (FIG. 1) are loaded into the respective hard drive 730. The network may comprise copper wires, optical fibers, wireless transmission, routers, firewalls, switches, gateway computers, and/or edge servers.

Each of the sets of external components 750 a, b can include a computer display monitor 721, a keyboard 731, and a computer mouse 735. External components 750 a, b can also include touch screens, virtual keyboards, touch pads, pointing devices, and other human interface devices. Each of the sets of internal components 710 a, b also includes device drivers 740 to interface to computer display monitor 721, keyboard 731, and computer mouse 735. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

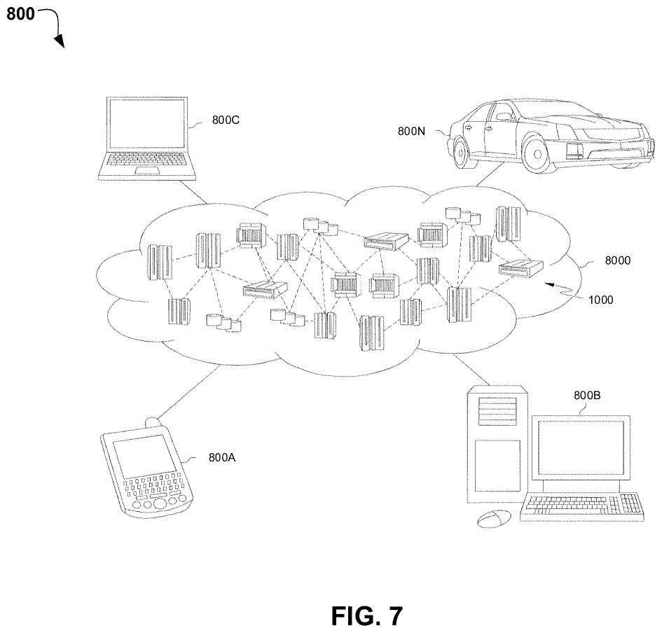

Referring now to FIG. 7, illustrative cloud computing environment 800 is depicted. As shown, cloud computing environment 800 comprises one or more cloud computing nodes 1000 with which local computing devices used by cloud consumers, such as, for example, personal digital assistant (PDA) or cellular telephone 800A, desktop computer 800B, laptop computer 800C, and/or automobile computer system 800N may communicate. Nodes 1000 may communicate with one another. They may be grouped (not shown) physically or virtually, in one or more networks, such as Private, Community, Public, or Hybrid clouds as described hereinabove, or a combination thereof. This allows cloud computing environment 8000 to offer infrastructure, platforms and/or software as services for which a cloud consumer does not need to maintain resources on a local computing device. It is understood that the types of computing devices 800A-N shown in FIG. 7 are intended to be illustrative only and that computing nodes 100 and cloud computing environment 8000 can communicate with any type of computerized device over any type of network and/or network addressable connection (e.g., using a web browser).

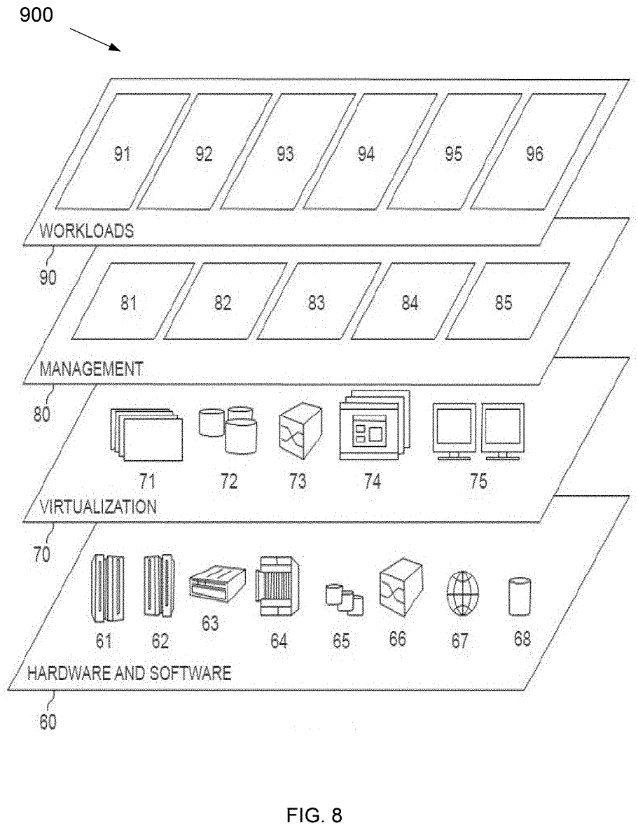

Referring now to FIG. 8, a set of functional abstraction layers 900 provided by cloud computing environment 800 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and comment overlay generator 96. A comment overlay generator program 108A, 108B (FIG. 1) may be offered “as a service in the cloud” (i.e., Software as a Service (SaaS)) for applications running on computing devices 102 (FIG. 1) and may automatically and cognitively generate a comment overlay window that is overlayed and displayed in a main window of a video and that includes text/keywords from user comments.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for enhancing a video, comprising:
generating an annotation matrix comprising extracted video content associated with a video;
generating a viewer feedback matrix comprising extracted and aggregated viewer feedback from a plurality of viewers of the video, wherein the aggregated viewer feedback comprises a plurality of comments and viewer actions associated with the video, and wherein the aggregated viewer feedback comprising the plurality of comments appears as text that is located separate from a main window for playing the video;
generating an overlay matrix by merging the viewer feedback matrix and the annotation matrix, wherein the overlay matrix correlates the aggregated viewer feedback with at least one context in the video and corresponding time points; and
generating at least one overlay window for overlaying in the main window of the video at a particular point in time during a playing of the video, wherein the at least one overlay window includes textual information generated from the aggregated viewer feedback, and wherein overlaying in the main window of the video at the particular point in time further comprises displaying the textual information at the particular point in time of the at least one context of the video related to the textual information.

2. The method of claim 1, wherein generating the annotation matrix further comprises:
transcribing audio of the video using a speech-to-text algorithm and identifying keywords in the transcribed audio; and
identifying objects rendered at various points in time in the video using an image recognition algorithm and a machine learning model.

3. The method of claim 1, wherein generating the viewer feedback matrix further comprises:
generating a keyword map by mapping keywords from each comment from the plurality of comments to a matrix node with timeframe and context information;
parsing the viewer actions and mapping the viewer actions to the keywords; and
weighting the keywords to account for the viewer actions and storing the keyword map in the viewer feedback matrix.

4. The method of claim 1, wherein the extracted and aggregated viewer feedback further comprises a frequency of keywords used in the plurality of comments, comment upvotes, comment downvotes, comment referrers, and video scrubbing activity.

5. The method of claim 1, wherein generating the viewer feedback matrix further comprises:
prompting a viewer via a chatbot to provide more information in response to a viewer comment missing timeframe or context information.

6. The method of claim 1, wherein generating the overlay matrix further comprises:
feeding the annotation matrix and the viewer feedback matrix into a machine learning model to correlate keywords and contexts from both the annotation matrix and the viewer feedback matrix.

7. The method of claim 1, further comprising:
adding the generated at least one overlay window to the video and playing the video.

8. A computer system for enhancing a video, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
generating an annotation matrix comprising extracted video content associated with a video;
generating a viewer feedback matrix comprising extracted and aggregated viewer feedback from a plurality of viewers of the video, wherein the aggregated viewer feedback comprises a plurality of comments and viewer actions associated with the video, and wherein the aggregated viewer feedback comprising the plurality of comments appears as text that is located separate from a main window for playing the video;
generating an overlay matrix by merging the viewer feedback matrix and the annotation matrix, wherein the overlay matrix correlates the aggregated viewer feedback with at least one context in the video and corresponding time points; and
generating at least one overlay window for overlaying in the main window of the video at a particular point in time during a playing of the video, wherein the at least one overlay window includes textual information generated from the aggregated viewer feedback, and wherein overlaying in the main window of the video at the particular point in time further comprises displaying the textual information at the particular point in time of the at least one context of the video related to the textual information.

9. The computer system of claim 8, wherein generating the annotation matrix further comprises:
transcribing audio of the video using a speech-to-text algorithm and identifying keywords in the transcribed audio; and
identifying objects rendered at various points in time in the video using an image recognition algorithm and a machine learning model.

10. The computer system of claim 8, wherein generating the viewer feedback matrix further comprises:
generating a keyword map by mapping keywords from each comment from the plurality of comments to a matrix node with timeframe and context information;
parsing the viewer actions and mapping the viewer actions to the keywords; and
weighting the keywords to account for the viewer actions and storing the keyword map in the viewer feedback matrix.

11. The computer system of claim 8, wherein the extracted and aggregated viewer feedback further comprises a frequency of keywords used in the plurality of comments, comment upvotes, comment downvotes, comment referrers, and video scrubbing activity.

12. The computer system of claim 8, wherein generating the viewer feedback matrix further comprises:
prompting a viewer via a chatbot to provide more information in response to a viewer comment missing timeframe or context information.

13. The computer system of claim 8, wherein generating the overlay matrix further comprises:
feeding the annotation matrix and the viewer feedback matrix into a machine learning model to correlate keywords and contexts from both the annotation matrix and the viewer feedback matrix.

14. The computer system of claim 8, further comprising:
adding the generated at least one overlay window to the video and playing the video.

15. A computer program product for enhancing a video, comprising:
one or more tangible computer-readable storage devices and program instructions stored on at least one of the one or more tangible computer-readable storage devices, the program instructions executable by a processor, the program instructions comprising:
generating an annotation matrix comprising extracted video content associated with a video;
generating a viewer feedback matrix comprising extracted and aggregated viewer feedback from a plurality of viewers of the video, wherein the aggregated viewer feedback comprises a plurality of comments and viewer actions associated with the video, and wherein the aggregated viewer feedback comprising the plurality of comments appears as text that is located separate from a main window for playing the video;
generating an overlay matrix by merging the viewer feedback matrix and the annotation matrix, wherein the overlay matrix correlates the aggregated viewer feedback with at least one context in the video and corresponding time points; and
generating at least one overlay window for overlaying in the main window of the video at a particular point in time during a playing of the video, wherein the at least one overlay window includes textual information generated from the aggregated viewer feedback, and wherein overlaying in the main window of the video at the particular point in time further comprises displaying the textual information at the particular point in time of the at least one context of the video related to the textual information.

16. The computer program product of claim 15, wherein the program instructions to generate the annotation matrix further comprises:
transcribing audio of the video using a speech-to-text algorithm and identifying keywords in the transcribed audio; and
identifying objects rendered at various points in time in the video using an image recognition algorithm and a machine learning model.

17. The computer program product of claim 15, wherein generating the viewer feedback matrix further comprises:
generating a keyword map by mapping keywords from each comment from the plurality of comments to a matrix node with timeframe and context information;
parsing the viewer actions and mapping the viewer actions to the keywords; and
weighting the keywords to account for the viewer actions and storing the keyword map in the viewer feedback matrix.

18. The computer program product of claim 15, wherein the extracted and aggregated viewer feedback further comprises a frequency of keywords used in the plurality of comments, comment upvotes, comment downvotes, comment referrers, and video scrubbing activity.

19. The computer program product of claim 15, wherein generating the viewer feedback matrix further comprises:
prompting a viewer via a chatbot to provide more information in response to a viewer comment missing timeframe or context information.

20. The computer program product of claim 15, wherein generating the overlay matrix further comprises:
feeding the annotation matrix and the viewer feedback matrix into a machine learning model to correlate keywords and contexts from both the annotation matrix and the viewer feedback matrix.
